(19) United States
(12) Patent Application Publication
(10) Pub. No.: US 2011/0157237 A1
(43) Pub. Date: Jun. 30, 2011

(54) METHOD FOR ADJUSTING FRAME BRIGHTNESS

(75) Inventors: Chao-Chinge Chen, Taipei County (TW); Pei-Tang Su, Taipei County (TW)

(73) Assignee: AMTRAN TECHNOLOGY CO. LTD, Taipei County (TW)

(21) Appl. No.: 12/701,593

(22) Filed: Feb. 7, 2010

(30) Foreign Application Priority Data
Dec. 31, 2009 (TW) 98146201

(51) Int. Cl. G09G 5/10

(52) U.S. Cl. 345/690

(57) ABSTRACT

A method for adjusting frame brightness is provided. First, an image data in YUV format is received. Next, a dimming curve is determined according to an overall average pixel level value of the image data and a number distribution of pixel level values. Then, the image data is divided into a plurality of blocks, and a block average pixel level value of pixels in each of the blocks is calculated. Thereafter, the block average pixel level values are substituted into the dimming curve to obtain a plurality of block brightness values. Afterward, the image data is outputted and backlight sources corresponding to each of the blocks are driven to provide the block brightness values to each of the blocks for displaying a frame.

### CROSS-REFERENCE TO RELATED APPLICATION

This application claims the priority benefit of Taiwan application serial no. 98146201, filed on Dec. 31, 2009. The entirety of the above-mentioned patent application is hereby incorporated by reference herein and made a part of specification.

### BACKGROUND OF THE INVENTION

1. Field of the Invention

The invention relates to a method for adjusting frame brightness, particularly to a method for adjusting frame brightness to enhance frame contrast.

2. Description of Related Art

In recent years, Flat Panel Display, such as Liquid Crystal Display (LCD), has been greatly developed. Liquid Crystal Display (LCD) has become a mainstream in the market due to its advantages such as low power consumption, absence of radiation, and high space utilization. A LCD mainly comprises a liquid crystal display panel and a backlight module. Since a liquid crystal display panel itself cannot emit light, it is necessary to have a backlight module to provide backlight sources required by the liquid crystal display panel.

Cold cathode fluorescent lamps (CCFLs) are usually used as light sources in conventional backlight modules. However, as the technology level of making light-emitting diodes rises, light-emitting diodes (LEDs) now have the advantages including small size, low operation voltage, long life span, and high color saturation. Therefore, using LEDs as a light source of a backlight module has become a new choice. Since LEDs in a backlight module are usually arranged in an array, the brightness of different LEDs can be individually adjusted.

### SUMMARY OF THE INVENTION

The invention provides a method for adjusting frame brightness that enhances frame contrast.

The method for the invention includes the following steps. First, an image data in YUV format is received. Next, a plurality of pixel level values of pixels of the image data are retrieved. Then, an overall average pixel level value of the pixel level values is calculated. In addition, a number distribution of the pixel level values is calculated. Afterward, a dimming curve is determined according to the overall average pixel level value and the number distribution of the pixel level values. Moreover, the image data is divided into a plurality of blocks, and an average pixel level value of pixels in each of the blocks is calculated. Next, the block average pixel level values are substituted into the dimming curve to obtain a plurality of block brightness values. Thereafter, the image data is outputted and backlight sources corresponding to each of the blocks are driven to provide brightness values to each of the blocks for displaying a frame.

In one embodiment of the adjusting method for the invention, steps of driving backlight sources corresponding to each of the blocks include the following steps. First, a plurality of pulse width modulation values corresponding to the block brightness values are generated. Next, a plurality of LEDs corresponding to each of the blocks are driven by the pulse width modulation values so as to provide the block brightness values.

Based on the above, the method for adjusting frame brightness of the invention individually adjusts the block brightness values provided by the backlight sources corresponding to each of the blocks so as to enhance frame contrast.

In order to make the aforementioned and other features and advantages of the invention more comprehensible, embodiments accompanying figures are described in detail below.

### BRIEF DESCRIPTION OF THE DRAWINGS

The accompanying drawings are included to provide a further understanding of the invention and are incorporated in and constitute a part of this specification. The drawings illustrate embodiments of the invention and, together with the description, serve to explain the principles of the invention.

FIG. 1 is a flowchart illustrating a method for adjusting frame brightness according to an exemplary embodiment of the invention.

FIG. 2 illustrates pixel level values of image data of an exemplary embodiment of the invention.

FIG. 3 is a histogram illustrating pixel level values of image data of an exemplary embodiment of the invention.

FIG. 4 is a dimming curve of image data of an exemplary embodiment of the invention.

FIGS. 5 and 6 explain two methods for determining dimming curves.

FIG. 7 is a flowchart illustrating steps of driving backlight sources.

FIG. 8 illustrates the relations between the backlight sources and image data.

### DESCRIPTION OF EMBODIMENTS

YUV is a color space. In other words, YUV is a format that stores color images. Y stands for luminance, luma, U stands for chrominance, and V stands for chroma. YUV is often used for describing analogue signals. Presently, YUV has been extensively used in computer systems. Since the limitation of human sensation is taken into consideration in the YUV format, using the YUV format to encode color images or video can reduces the bandwidth of chrominance. Therefore, compared with a RGB format, YUV format effectively enables viewers to ignore transmission errors or distortion.

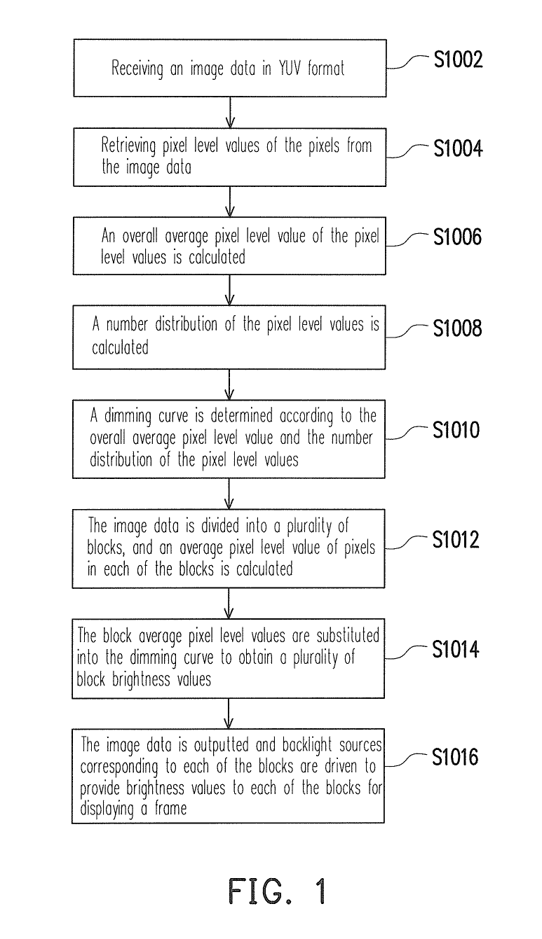

FIG. 1 is a flowchart illustrating a method for adjusting frame brightness according to an exemplary embodiment of the invention. By using Steps S1002-S1016, frame brightness is adjusted. The details of Steps S1002-S1016 are provided hereafter.

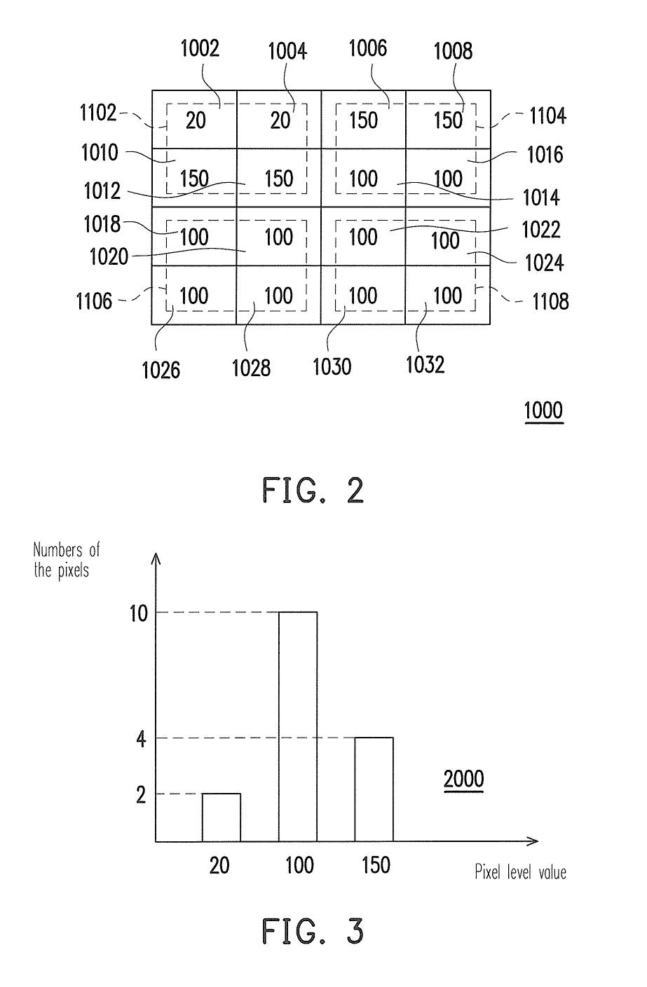

FIG. 2 illustrates pixel level values of image data 1000 of an exemplary embodiment of the invention. Referring to FIGS. 1 and 2, the image data 1000 is in 4*4 YUV format and uses 8 bits to show pixel level values. First, Step S1002 is performed to receive the image data 1000 in YUV format. Next, Step S1004 is performed to retrieve pixels 1002-1032 from the image data 1000. The pixel level values of the pixels 1002-1032 retrieved are 20, 20, 150, 150, 150, 150, 100, 100, 100, 100, 100, 100, 100, 100, 100, and 100, respectively. In Step S1006, an overall average pixel level value of the pixels 1002-1032 is about 54. For the convenience of explanation, the overall average pixel level values in this embodiment are rounded up or down to the fifth to be an integer, but the invention is not limited in this embodiment.

FIG. 3 is a histogram illustrating pixel level values of the image data 1000 of an exemplary embodiment of the invention. The x-axis in FIG. 3 represents pixel level values, and the y-axis in FIG. 3 represents the pixel numbers. Referring to FIGS. 1 and 2, in Step S1008, FIG. 3 is obtained by summing up the number distribution of brightness values of the pixels 1002-1032. By using the statistical method in a histogram 2000 of pixel level values, it can be known that when the pixel level value is 20, the pixel number is 2, when the pixel level value is 100, the pixel number is 10, and when the pixel level value is 150, the pixel number is 4. In this embodiment, the statistical method in the histogram 2000 of pixel level values is used for summing up the number distribution of pixel level values, but the invention is not limited in this embodiment and can be embodied by any other methods, for example, average values and standard deviation.

Referring to FIGS. 1 and 2, in Step S1010, a dimming curve 3000 is determined according to the overall average pixel level value and the number distribution of the pixel level values (here referring to the histogram 2000 of pixel level values of FIG. 3).

In Step S1012, the image data 1000 is divided into a plurality of blocks, so pixels 1002, 1004, 1010, and 1012 belong to a block 1102, pixels 1006, 1008, 1014, and 1016 belong to a block 1104, pixels 1018, 1020, 1026, and 1028 belong to a block 1106, and pixels 1022, 1024, 1030, and 1032 belong to a block 1108. Next, a block average pixel level value in each of the blocks 1102-1108 is calculated. The block average pixel level value of the block 1102 is 75, the block average pixel level value of the block 1104 is 125, the block average pixel level value of the block 1106 is 100, and the block average pixel level value of the block 1108 is 100.

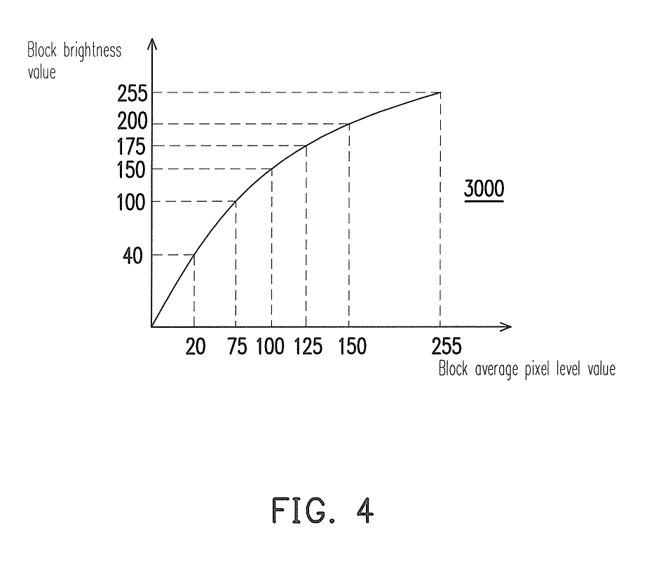

FIG. 4 is a dimming curve of the image data 1000 of an exemplary embodiment of the invention. The x-axis in FIG. 4 represents block average pixel level values, and the y-axis in FIG. 4 represents block brightness values. Referring to FIGS. 1 and 2, in Step S1014, the block average pixel level values of the blocks 1102-1108 are substituted into the dimming curve 3000 in FIG. 4 so as to obtain a plurality of block brightness values. By substituting the block average pixel level value of 75 of the block 1102 into the dimming curve 3000, a block brightness value of 100 is obtained. By substituting the block average pixel level value of 125 of the block 1104 into the dimming curve 3000, a block brightness value of 175 is obtained. By substituting the block average pixel level value of 100 of the block 1106 into the dimming curve 3000, a block brightness value of 150 is obtained. By substituting the block average pixel level value of 100 of the block 1108 into the dimming curve 3000, a block brightness value of 150 is obtained.

In Step S1016, the image data 1000 is outputted and backlight sources corresponding to each of the blocks 1102-1108 are driven to provide brightness values to the blocks for displaying a frame. Here the block brightness values corresponding to the blocks 1102-1108 are 100, 175, 150, and 150, respectively.

In this embodiment, the dimming curve 3000 is determined according to pixel level values and an overall average brightness. Next, the block average pixel level value are substituted into the dimming curve 3000 so as to obtain a plurality of block brightness values. Afterward backlight sources corresponding to each of the blocks 1102-1108 are driven by each of the block brightness values, so different level of brightness can be provided by the backlight sources corresponding to each of the blocks 1102-1108. As a result, for instance, a backlight source of lower brightness is provided to a block with a darker frame, while a backlight source of higher brightness is provided to a block with a brighter frame. Compared with those methods with one single level of brightness of backlight sources, this embodiment can enhance the frame contrast.

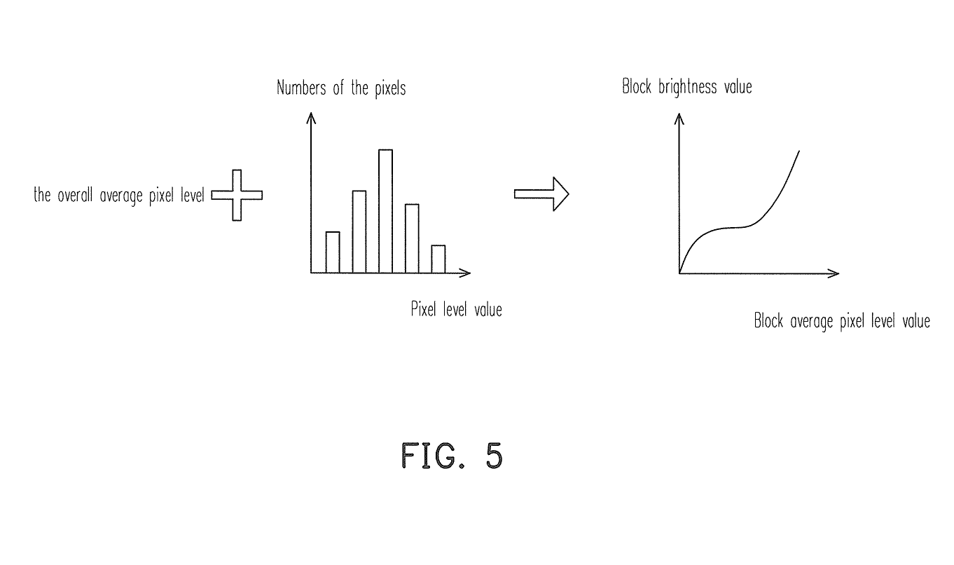

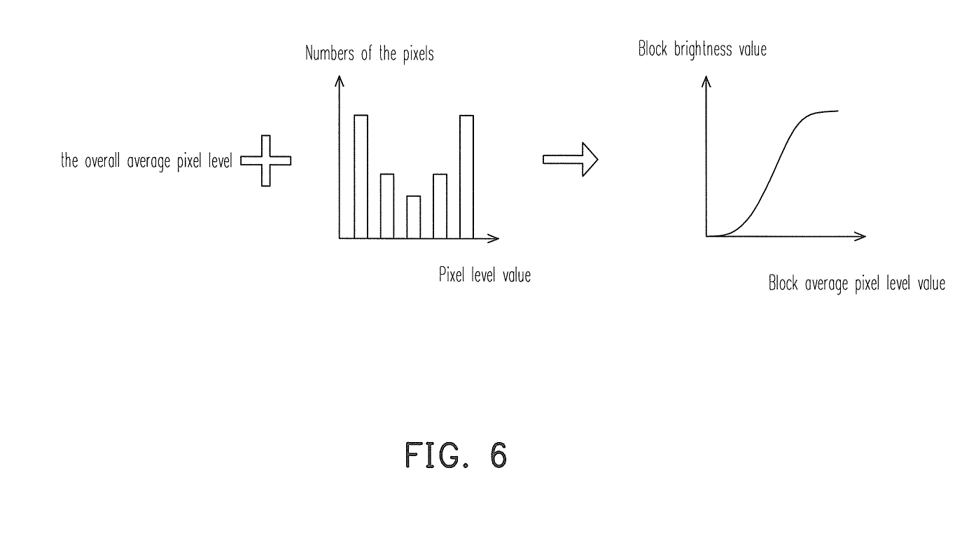

FIGS. 5 and 6 explain two methods for determining dimming curves. Step S1010 of FIG. 1 determines a dimming curve according to the overall average pixel level value and the number distribution of the pixel level values. For example, when the number distribution of the pixel level values is bell-shaped, a dimming curve as shown in FIG. 5 can be determined by further considering the overall average pixel level value. When the number distribution of the pixel level values is presented as FIG. 5, numbers of the pixels with high pixel, level values and pixels with low pixel level values are fewer, the dimming curve is gradual in the section of middle block average pixel level values, and the dimming curve has larger slopes in the sections of high and low block average pixel level values. When the number distribution of the pixel level values is M-shaped, a dimming curve as shown in FIG. 6 can be determined by further considering the overall average pixel level value. When the number distribution of the pixel level values is presented as FIG. 6, numbers of the pixels with high pixel level values and pixels with low pixel level values are more, the dimming curve has larger slope in the section of middle block average pixel level values, and the dimming curve are gradual in the sections of high and low block average pixel level values. It should be noted that the “+” in FIGS. 5 and 6 are not the addition in the mathematical operation, the “+” in FIGS. 5 and 6 present that the dimming curves are determined according to the overall average pixel level value and the number distribution of the pixel level values synthetically.

Meanwhile, when the number distribution of the pixel level values is L-shaped, reversed L-shaped or others, a dimming curve still can be determined by further considering the overall average pixel level value. In this way, different dimming curves can be obtained according to different number distributions of the pixel level values, and image with better contrast can be obtained by outputting different pulse width modulation values to drive the backlight source.

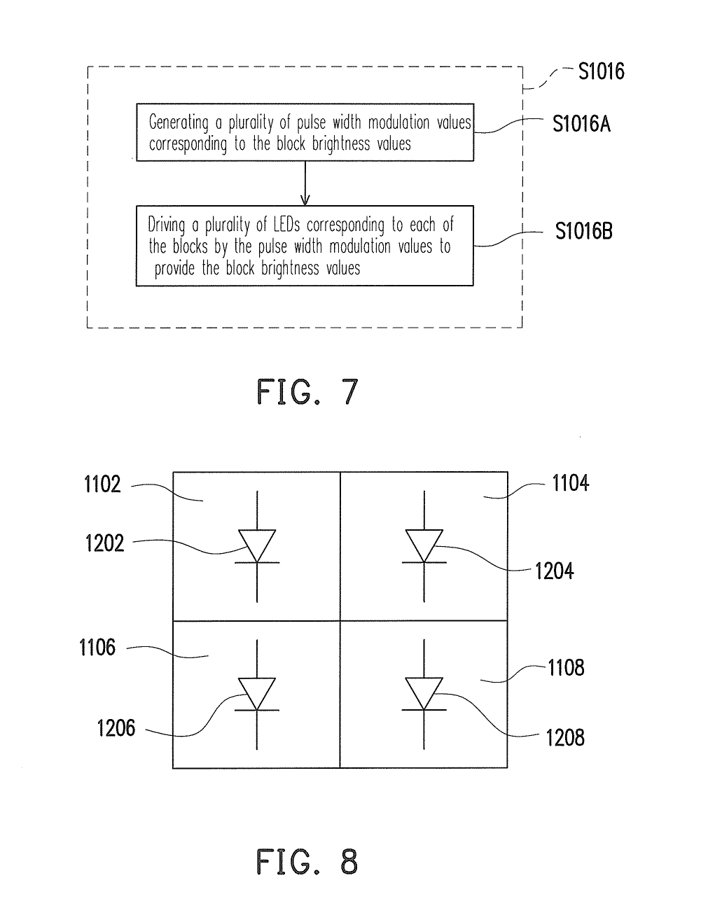

FIG. 7 is a flowchart illustrating the steps of driving the backlight sources, and FIG. 8 shows the relations between backlight sources and blocks of image data. Referring to FIGS. 7 and 8, the backlight sources corresponding to the blocks 1102, 1104, 1106, and 1108 of the image data 1000 are LEDs 1202, 1204, 1206, and 1208, respectively. Step S1016 in FIG. 1 is further divided into the following steps. First, in Step S1016A, a plurality of pulse width modulation values corresponding to the block brightness values are generated, and here the block brightness values corresponding to the blocks 1102-1108 are 100, 175, 150, and 150, respectively. Next, in Step S1016B, the LEDs 1202-1208 corresponding to the blocks 1102-1108 are driven by the pulse width modulation values so as to provide block brightness values, and here the block brightness values are 100, 175, 150, and 150. For the convenience of explanation, here the LEDs 1202-1208 are only represented respectively by a single LED, but the invention is not limited in this embodiment.

Based on the above, in the method for adjusting frame brightness of the invention, a dimming curve is first determined according to pixel level values and an overall average pixel level value, next, a block average pixel level values are substituted into the dimming curve to obtain a plurality of block brightness values, and then backlight sources corresponding to each of the blocks are driven to provide the block brightness values to each of the blocks. Since the block brightness provided by the backlight sources to each of the blocks is different, an optimum frame contrast is obtained by each of the blocks.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A method for adjusting frame brightness, comprising:
receiving an image data, wherein the image data is in YUV format;
retrieving a plurality of pixel level values of a plurality of pixels of the image data;
calculating an overall average pixel level value of the pixel level values;
summing up a number distribution of the pixel level values;
determining a dimming curve according to the overall average pixel level value and the number distribution of the pixel level values;
dividing the image data into a plurality of blocks, calculating a block average pixel level value of each of the blocks;
substituting the block average pixel level values into the dimming curve to obtain a plurality of block brightness values; and
outputting the image data and driving backlight sources corresponding to each of the blocks to provide the block brightness values to each of the blocks for displaying a frame.

2. The method for adjusting frame brightness according to claim 1, wherein steps of driving the backlight sources corresponding to each of the blocks comprising:
generating a plurality of pulse width modulation values corresponding to the block brightness values; and
driving a plurality of LEDs corresponding to each of the blocks by the pulse width modulation values to provide the block brightness values.
